(19) United States
(12) Patent Application Publication
(10) Pub. No.: US 2025/0231575 A1
(43) Pub. Date: Jul. 17, 2025

(54) USER INPUT DEVICE WITH YOKE STICK AND RELATED METHODS

(71) Applicant: Axel Lopez Consulting, LLC, Orlando, FL (US)

(72) Inventors: Alejandro Madrid Aldana, Kissimmee, FL (US); Axel G Lopez, Orlando, FL (US)

(21) Appl. No.: 19/018,008

(22) Filed: Jan. 13, 2025

Related U.S. Application Data
(60) Provisional application No. 63/620,433, filed on Jan. 12, 2024.

(51) Int. Cl. G05G 9/047; G05D 1/223; G05D 109/20

(52) U.S. Cl. CPC G05G 9/047; G05D 1/223; G05D 2109/20; G05G 2009/04755

(57) ABSTRACT

A user input device may include a housing, and a yoke stick extending from the housing. The yoke stick may comprise an elongate portion, and a longitudinal motion module receiving the elongate portion and having a longitudinal module housing, a piston longitudinally received within the longitudinal module housing, first and second elastic devices carried within the longitudinal module housing and biasing the piston in a medial position, and a longitudinal sensor carried by the longitudinal module housing and configured to detect z-axis motion of the yoke stick. The user input device also includes a controller carried by the housing and coupled to the longitudinal sensor, a first translation motion module, a second translation motion module, and a rotational motion module, the controller configured to generate a motion input signal based upon four-axis motion of the yoke stick.

### RELATED APPLICATION

This application is based upon prior filed copending Application No. 63/620,433 filed Jan. 12, 2024, the entire subject matter of which is incorporated herein by reference in its entirety.

### TECHNICAL FIELD

The present disclosure relates to the field of user input controls, and, more particularly, to a user input control with a yoke stick related methods.

### BACKGROUND

Input devices are ubiquitous in the digital age, and are commonly used for converting user input into an output signal for a device to be controlled. Indeed, input devices are applied in a wide variety of devices, ranging from video games/simulator controllers to complex robotic systems (e.g., manufacturing, ordinance disposal, search and rescue missions, environmental analysis, or inspection at toxic sights).

In typical input devices, the input device measures user inputs using one or more sensors and converts the sensed user input into corresponding output signals that are transmitted to the destination electronic device to be controlled. For example, in the robotic system application, the user inputs will cause it to move in a desired manner in accordance with the transmitted output signals. In one common input device for the robotic system, a joystick device measures angle and direction of mechanical input, and generates the output signal.

### SUMMARY

Generally, a user input device may include a housing, and a yoke stick extending from the housing. The yoke stick may comprise an elongate portion, and a longitudinal motion module receiving the elongate portion and having a longitudinal module housing, a piston longitudinally received within the longitudinal module housing, first and second elastic devices carried within the longitudinal module housing and biasing the piston in a medial position, and at least one longitudinal sensor carried by the longitudinal module housing and configured to detect z-axis motion of the yoke stick. The yoke stick may include a first translation motion module coupled to the longitudinal motion module and configured to detect x-axis motion of the yoke stick, a second translation motion module coupled to the first translation motion module and configured to detect y-axis motion of the yoke stick, and a rotational motion module configured to detect rotational motion about the z-axis of the yoke stick. The user input device also includes a controller carried by the housing and coupled to the at least one longitudinal sensor, the first translation motion module, the second translation motion module, and the rotational motion module. The controller may be configured to generate a motion input signal based upon four-axis motion of the yoke stick.

In some embodiments, the at least one longitudinal sensor may comprise a plurality of longitudinal sensors radially spaced about the longitudinal module housing, and the longitudinal motion module may comprise a plurality of magnets carried by the piston. The controller may be configured to average respective output values from the plurality of longitudinal sensors to generate a value for the z-axis motion of the yoke stick. Also, the longitudinal module housing may define a plurality of longitudinal channels, and the piston may define a plurality longitudinal ridges respectively received by the plurality of longitudinal channels.

Further, the rotational motion module may further comprise a rotational module housing coupled to an upper end of the elongate portion, and a plate received within the rotational module housing and freely rotating therein, the plate being coupled to an uppermost end of the yoke stick. The rotational motion module may comprise a plurality of rotational sensors carried by the plate and configured to detect a rotational position of the plate with respect to the rotational module housing. Each of the first translation motion module and the second translation motion module may comprise a pivot bar, and support arms coupled thereto. The pivot bar of the second translation motion module may be coupled to the support arms of the first translation motion module. For example, the at least one longitudinal sensor may comprise at least one Hall effect sensor.

Another aspect is directed to an unmanned aerial vehicle (UAV) system. The UAV system may include a UAV, and a user input device in communication with the UAV and configured to control the UAV based upon a motion input signal. The user input device may include a housing, and a yoke stick extending from the housing. The yoke stick may comprise an elongate portion, and a longitudinal motion module receiving the elongate portion and having a longitudinal module housing, a piston longitudinally received within the longitudinal module housing, first and second elastic devices carried within the longitudinal module housing and biasing the piston in a medial position, and at least one longitudinal sensor carried by the longitudinal module housing and configured to detect z-axis motion of the yoke stick. The yoke stick may include a first translation motion module coupled to the longitudinal motion module and configured to detect x-axis motion of the yoke stick, a second translation motion module coupled to the first translation motion module and configured to detect y-axis motion of the yoke stick, and a rotational motion module configured to detect rotational motion about the z-axis of the yoke stick. The user input device also includes a controller carried by the housing and coupled to the at least one longitudinal sensor, the first translation motion module, the second translation motion module, and the rotational motion module. The controller may be configured to generate the motion input signal based upon four-axis motion of the yoke stick.

### BRIEF DESCRIPTION OF THE DRAWINGS

FIG. 1 is a schematic perspective view of a user input device and user in an exemplary application, according to a first embodiment of the present disclosure.

FIGS. 2-3 are perspective views of the user input device of FIG. 1.

FIG. 4 is a side view of the yoke stick from the user input device of FIG. 1 without a yoke housing.

FIGS. 5A & 5B are schematic diagrams of first and second embodiments of the Hall sensor arrangement from the user input device of FIG. 1.

FIGS. 6A & 6B are schematic side and top views of the longitudinal sensors of the longitudinal motion module from the user input device of FIG. 1, respectively.

FIGS. 7A & 7B are schematic side and top views of the rotational sensors of the rotational motion module from the user input device of FIG. 1, respectively.

FIG. 8 is a schematic diagram of the controller from the user input device of FIG. 1.

FIG. 9 is an image of the user input device, according to a second embodiment of the present disclosure.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

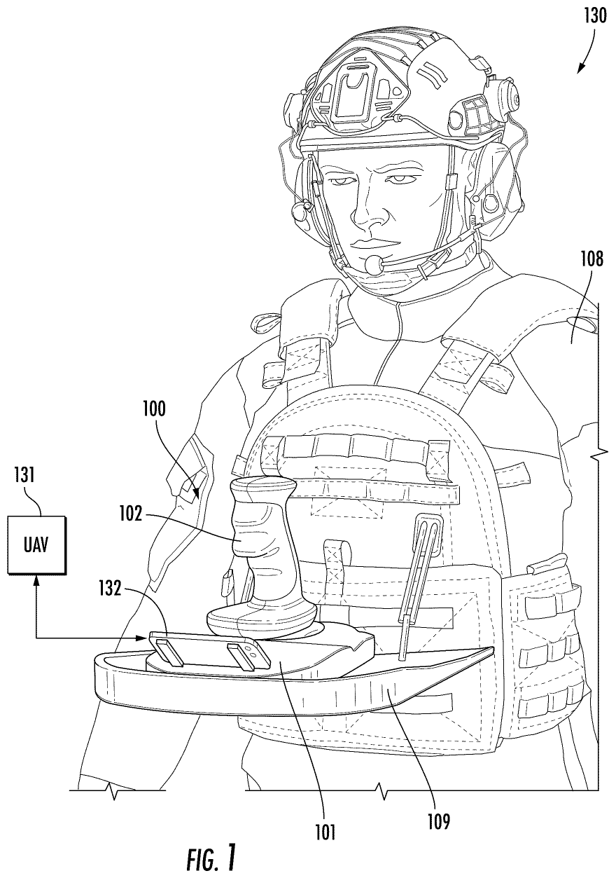

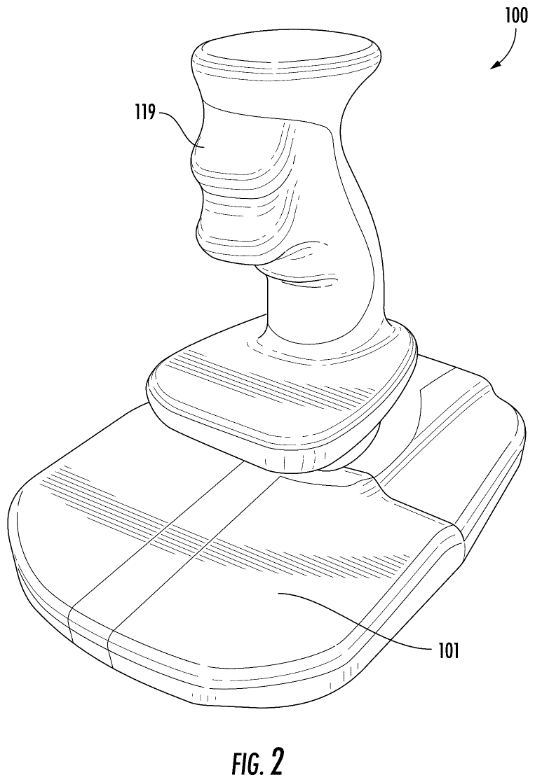

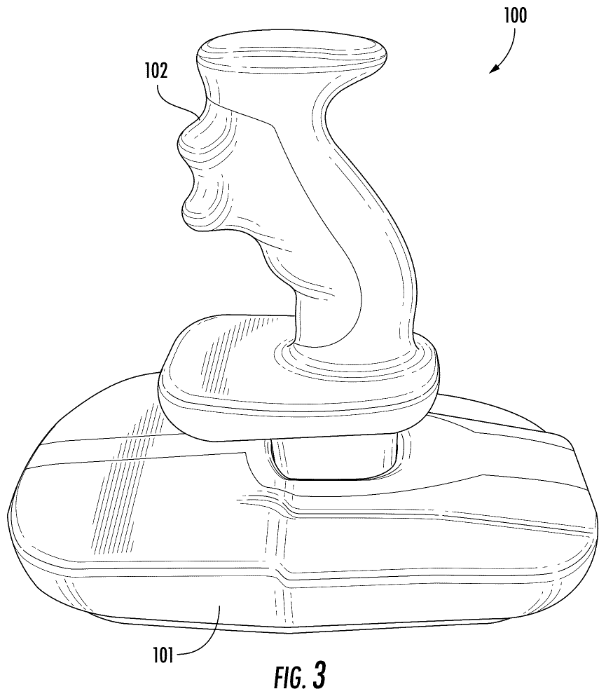

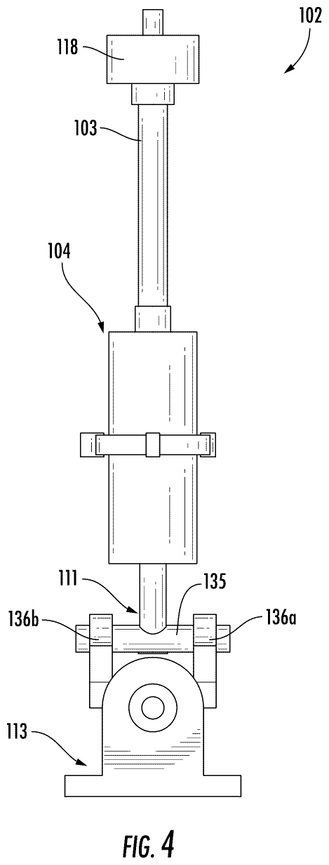

Referring to FIGS. 1-4, 5A-5B, 6A-6B, & 7A-7B, a user input device 100 according to the present disclosure is now described. As will be appreciated, the user input device 100 is illustratively deployed in an exemplary mobile application with a user 108. Here, the user input device 100 is carried by a folding platform 109 attached to the user 108 for control of an unmanned aerial vehicle (UAV). Of course, the user input device 100 may be used in any application that uses a user input device, for example, aviation, gaming, or industrial vehicles.

The user input device 100 includes a base housing 101, and a yoke stick 102 extending from the housing. Also, the yoke stick 102 illustratively includes a yoke housing surrounding the below described internal components and for gripping by the user 108. This yoke housing is mostly made of PA6-CF Nylon. For example, the yoke housing and structure are made of PA6-CF, which is a carbon fiber reinforced PA6 (Nylon 6) filament. The carbon fiber reinforcement provides significantly improved stiffness, strength, and heat resistance while remaining light. This material is well suited for any kind of machinery resistance due to heavy work or video game anxiety. TPU-95 is a thermoplastic polyurethane (TPU). It has a shore hardness of 95A and can stretch more than three times its original length. This smooth material provides a softness and the flexibility to physically hide the trigger buttons under this material as well give the cozy comfort on the yoke housing.

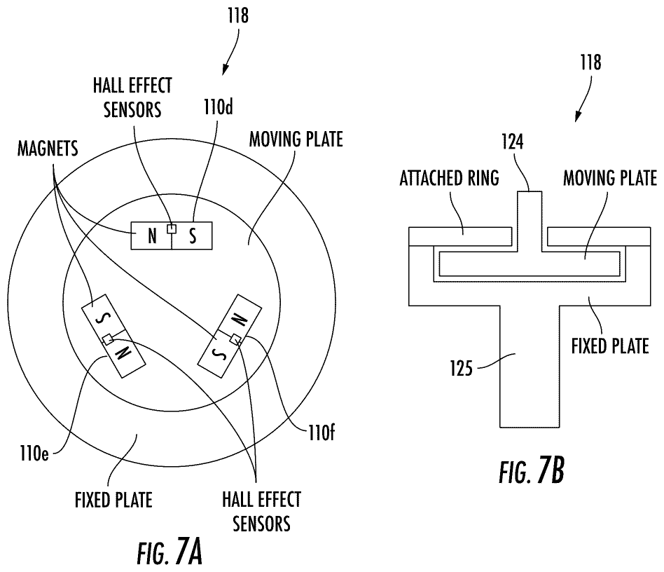

The yoke stick 102 illustratively includes an elongate portion 103. The yoke stick 102 includes a longitudinal motion module 104 receiving the elongate portion 103 and configured to detect longitudinal motion (i.e., z-axis motion) of the yoke stick, and a rotational motion module 118 configured to detect rotational motion about the z-axis of the yoke stick. The longitudinal motion module 104 illustratively includes a longitudinal housing 105, a piston 106 longitudinally received therein, first and second elastic devices 107a-107b carried by the longitudinal housing and biasing the piston in a medial/floating position, and longitudinal sensors 110a-110c carried by the longitudinal housing and configured to detect a longitudinal position of the piston. As perhaps best seen in FIGS. 7A-7B, the rotational motion module 118 illustratively comprises rotational sensors 110d-110f carried by a moving plate and configured to detect a rotational position of the moving plate 124 with respect to the fixed plate 125 inside the rotational motion module.

The yoke stick 102 illustratively includes a first translation motion module 111 coupled to the longitudinal motion module 104 and configured to detect x-axis motion of the yoke stick. The first translation motion module 111 illustratively includes first arm coupled to the longitudinal motion module 104, a pivot bar transversely coupled to the first arm, support arms coupled to the pivot bar, and first translation sensors 112a-112b carried by either the pivot bar or the support arms and configured to detect an x-position of the yoke stick 102.

The yoke stick 102 illustratively includes a second translation motion module 113 coupled to the first translation motion module 111 and configured to detect y-axis motion of the yoke stick. It should be appreciated that the first translation motion module 111 and the second translation motion module 113 may respectively detect motion y-axis and x-axis motion, in other words, a 90° rotation or reversal of axes.

The second translation motion module 113 illustratively includes a pivot bar transversely coupled to the support arms of the first translation motion module 111, support arms coupled to the pivot bar, and second translation sensors 114a-114b carried by either the pivot bar or the support arms and configured to detect a y-position of the yoke stick 102.

The user input device 100 further comprises a controller 115 carried by the base housing 101 and coupled to the plurality of sensors 110a-110f, 112a-112b, 114a-114b, 120a-120b. The controller 115 is configured to generate a motion output signal based upon four-axis motion of the yoke stick 102.

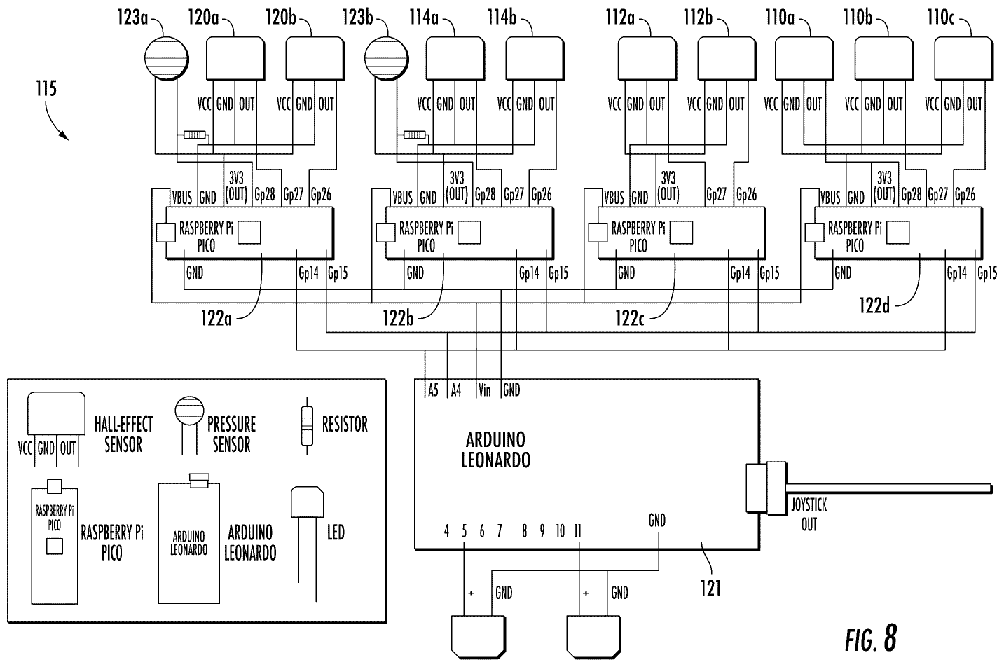

As perhaps best seen in FIG. 8, the controller 115 illustratively includes a processor 121, and a plurality of microcontrollers 122a-122d coupled to the processor. In cooperation with the processor 121, the microcontrollers 122a-122d are respectively coupled to the plurality of sensors 110a-110f, 112a-112b, 114a-114b, 120a-120b and responsible for determining position values for the X-axis, the Y-axis, the Z-axis, and a rotation about the Z-axis. For accuracy, each axis of motion has multiple sensors, and the outputs are averaged to provide more reliable values.

The yoke stick 102 illustratively comprises first and second pressure sensors 123a-123b coupled to the first and second microcontrollers 122a-122b. Although not depicted, the yoke stick 102 may comprise first and second buttons carried by the yoke housing 119 and for additional user input. The first and second buttons may be coupled to the first and second pressure sensors 123a-123b to provide a range of input values for each button.

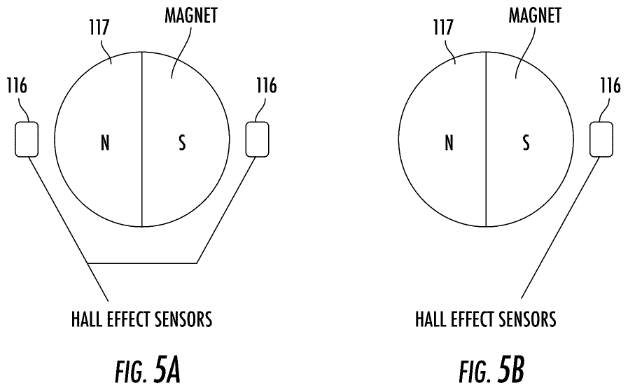

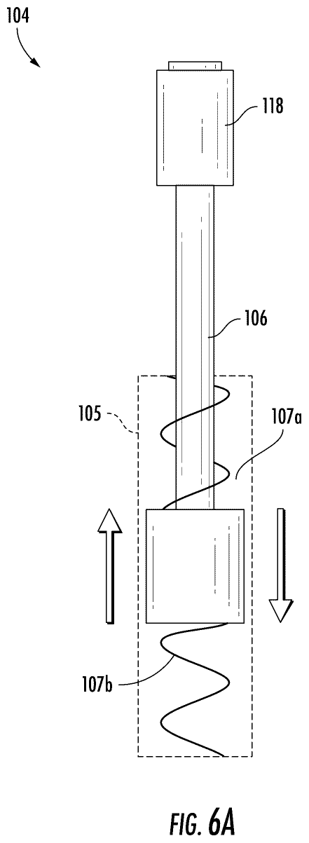

In some embodiments, and as perhaps best seen in FIGS. 5A-5B, each of the plurality of sensors 110a-110f, 112a-112b, 114a-114b, 120a-120b may include a Hall effect sensor arrangement (i.e., Hall sensor 116 and associated magnet 117).

Another aspect is directed to making a user input device 100. The method includes positioning a yoke stick 102 extending from a base housing 101 and including an elongate portion 103. The yoke stick 102 includes a longitudinal motion module 104 receiving the elongate portion and configured to detect z-axis motion of the yoke stick, a first translation motion module 111 coupled to the longitudinal motion module and configured to detect x-axis motion of the yoke stick, a second translation motion module 113 coupled to the first translation motion module and configured to detect y-axis motion of the yoke stick, and a rotational motion module 118 configured to detect rotational motion about the z-axis of the yoke stick. The user input device 100 further comprises a plurality of sensors 110a-110f, 112a-112b, 114a-114b, 120a-120b carried by the longitudinal motion module 104, the first translation motion module 111, and the second translation motion module 113. The method further comprises coupling a controller 115 carried by the base housing 101 to the plurality of sensors 110a-110f, 112a-112b, 114a-114b, 120a-120b. The controller 115 is configured to generate a motion input signal based upon four-axis motion of the yoke stick 102.

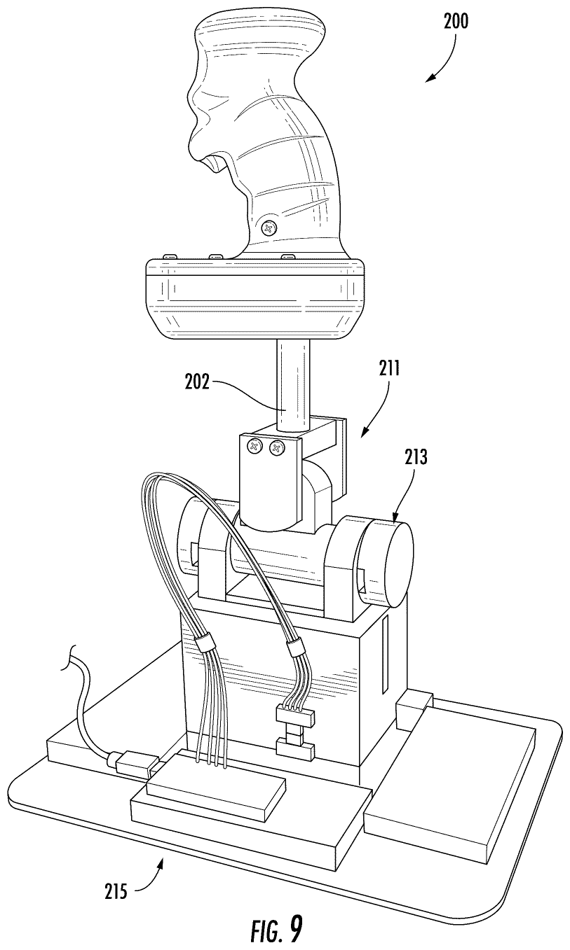

Referring now additionally to FIG. 9, another embodiment of the user input device 200 is now described. In this embodiment of the user input device 200, those elements already discussed above with respect to FIGS. 1-8 are incremented by 100 and most require no further discussion herein. This embodiment differs from the previous embodiment in that this user input device 200 illustratively includes no housing.

Helpfully, the user input device 100, 200 can be manipulated by a single hand, and provides four dimensions of input (i.e., left-right, front-rear, vertical shaft rotation, vertical shaft retraction and extension). As will be appreciated, this permits a user to use the user input device 100, 200 yet leaving one hand free for other applications.

Initially, video games were first designed to be played on a two-dimensional screen. Then, these games started evolving but the controls became more advanced, more complex with more bottoms and multiple small joysticks to control different axes. When three dimensional (3D) games were released to the market, another joystick was added to the control for the new axes. However, there was never a simpler way to control the 4 axes to play the new 3D games. Everything was controlled separately but not all-in-one, everything incorporated.

Most of the movies show a future where we control everything by adding more buttons or controls to it. However, the best way to do this is to make it simpler with less buttons and easy to control, so less effort is required to control different things or surfaces. The idea is to make this control easier for humans to almost incorporate them into human physiology like thought. The present disclosure provides an approach to this drawback of current approaches, a complete incorporated yoke.

In other fields or machines, it is possible to find yokes that control movement in two axes. For example, certain airplanes have a joystick that controls the movement upward and downward, Z-axis, as well as right and left, X-axis. However, the yoke described in the present disclosure controls movement in all 4 axes, upward/downward (Z-axis), forward/downward (Y-axis), and left/right (X-axis), and as well as stationary rotation clockwise/counterclockwise twisting left/right (rotation of Z).

The operation of the user input device 100, 200 (yoke) will be as follows: to go up pull it up, to go down push it down, to move forward just push forward, to move backward just pull backwards, to go right push right, to go left push left, and finally, to twist left or right just twist the yoke left or right. Equally, to achieve any move that results from the combination of other moves, it is only required to perform a combined action. For instance, to climb while moving forward, the required action is to pull up the yoke while pushing it forward. Finally, to go back to normal position, it only required to release the user input device 100, 200.

The Challenge of Turning Position into Information (Functional Description)

For machines to perform a desired task, it is necessary to have methods to control its operation. In the early days of industry, these methods relied on physical mechanisms that modified the physical state of the machinery. For instance, the pedals and joystick of the first aircraft were designed to control the chains and pulleys that caused a displacement on the control surfaces. Controls, then, were not further simplified since trying to create a simplified system would imply great mechanical complications. With the advancements of digital computing, electronic methods of control are demonstrated to be more reliable and scalable that mechanical methods. Therefore, levers, wheels, and pedals were no longer components in a mechanical system but rather in a user interface. Companies have started developing methods to turn a physical position into information with potentiometers being the most widely used method. Even though these new sensing methods allowed the design of simplified user interfaces, these interfaces focused on emulating mechanical controls. Consequently, every time a new part was introduced, a new component was included in the user interface. This present disclosure provides a user input device 100, 200, which serves as a universal user interface for multiple applications, so it is necessary to describe how this control system converts a physical position into useful information.

Currently, most electronic control systems rely on potentiometers to capture a physical position. However, potentiometers possess a major disadvantage: they are partially mechanical parts. Potentiometers are variable electrical resistances, which rely on shafts or rods that travel through resistive tracks. Therefore, when the physical position changes, movement occurs inside the potentiometer which leads to wear and malfunction. To avoid this inconvenience, the present disclosure provides a user input device 100, 200 that relies on magnets and Hall effect sensors. To clarify, Hall effect sensors are all sensors that rely on the Hall effect for its operation, and the control is not limited to a specific type of Hall effect sensor. The Hall effect, briefly exposed, is a natural phenomenon that can be described as a potential difference (voltage) between two different parts of a conducting material; this potential difference occurs when a current is travelling through a conducting material which is exposed to a magnetic field. The potential difference can be easily measured and changes as the magnetic field changes. Therefore, by placing a magnet in a moving part and a Hall effect sensor in a fixed part (or vice versa), it is possible to determine the physical position of the moving part.

Even though the movement on each axis can be sensed by using the same principle, it is useful to describe the ideal arrangement for each. First, the movement in the X-axis (left and right) is possible thanks to two shaft supports (fixed part) and a shaft (moving part), which is kept in a neutral position due to an arrangement of springs. On each tip of the shaft a small diametrically magnetized magnet is located. On one of the supports, one Hall effect sensor is located facing one of the magnets; likewise, on the other support another Hall effect sensor is located facing its corresponding magnet. The same objective can be achieved by placing the magnets in the supports and the sensors in the shaft. The movement in the Y-axis (forward and backward) is possible and sensed for a similar arrangement to the X-axis with the difference that the supports for the Y-axis shaft are mounted over the shaft of the X-axis. These two axes alone allow movement in two dimensions.

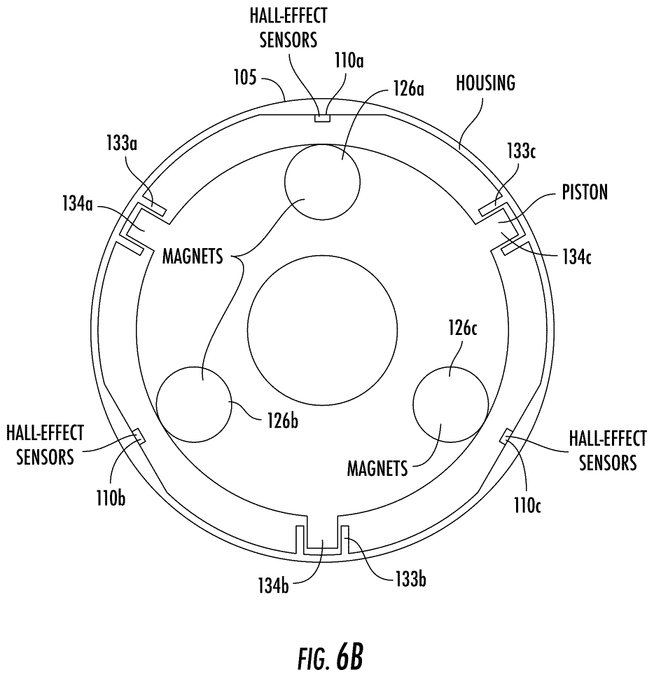

With reference to FIGS. 6A-6B, the movement in the Z-axis is discussed. To allow the vertical movement of the yoke, a piston housing (fixed part) is needed while a piston (moving part) protrudes from this housing. The piston is kept in a central position due to a spring under it and a spring over it. To determine the position, three axially magnetized magnets embedded to the piston are facing three Hall effect sensors embedded in the housing. It is important to remark that if the magnets are embedded to the housing and the sensors are embedded to the piston, the same task is accomplished.

With reference to FIGS. 7A-7B, the rotation of the Z-axis (rotation in the x-y plane) is discussed. To achieve this rotation, two plates are required: a plate with a cylindrical hole, which is fixed; and a second plate with a bump (moving part), which is free to rotate in this hole. To prevent undesired displacement in the Z-axis, a ring plate is attached to the fixed plate, so the moving plate is not allowed to move upwards nor downwards. Furthermore, the moving plate is also kept in a neutral position due to an arrangement of springs. Three axially magnetized magnets are organized in a radial array in the fixed plate, so they face three Hall effect sensors organized in a radial array in the moving plate. Once again if the place of the magnets and sensors is interchanged, the result is the same.

Any mounting order of the previous mechanisms can be used, and the mechanism previously exposed will hold. Likewise, the fact that there is more than one sensor for each movement makes the universal yoke exposed perfect for sensitive applications which require redundancies for security reasons.

Referring to FIG. 8, the controller 115 responsible for interpreting the potential differences and determining the correct position in case of an incidental failure is the electronic system of the yoke. This system is composed of four slave microcontrollers and a master microcontroller/computer. Each Hall effect sensor is connected to a slave microcontroller. In case the microcontroller desired has a low analog input resolution, an additional analog-to-digital converter would be required as a mediator between the sensor and the slave microcontroller. Moreover, the slave microcontrollers are connected to the master, which can be a computer or microcontroller depending on the calculations required for each application. This master microcontroller/computer collects the information of all the sensors, determines the correct position of the yoke, and sends the compiled information to the required system (i.e., a PC, game console, or flight computer).

The user input device 100, 200 was ergonomically designed to the human hand anatomy, specifically in a relaxed position. The yoke was designed with the shape of a human hand on a relax portion which means a hand laying without enforcing a force so the human can easily adjust to the handler comfortably.

Referring now to FIGS. 1-4, 6A-6B, 7A-7B, and 8, a UAV system 130 according to the present disclosure is now described. The UAV system 130 illustratively includes a UAV 131, and a user input device 100 in communication with the UAV and configured to control the UAV based upon a motion input signal generated based upon input from a user 108. The user input device 100 illustratively includes a housing 101, and a yoke stick 102 extending from the housing. The yoke stick 102 comprises an elongate portion 103, and a longitudinal motion module 104 receiving the elongate portion and having a longitudinal module housing 105, a piston 106 longitudinally received within the longitudinal module housing, first and second elastic devices 107a-107b carried within the longitudinal module housing and biasing the piston in a medial position, a plurality of longitudinal sensors 110a-110c radially spaced about the longitudinal module housing and configured to detect z-axis motion of the yoke stick, and a plurality of magnets 126a-126c carried by the piston and cooperating with the plurality of longitudinal sensors.

The yoke stick 102 illustratively comprises a first translation motion module 111 coupled to the longitudinal motion module 104 and configured to detect x-axis motion of the yoke stick 102, a second translation motion module 113 coupled to the first translation motion module and configured to detect y-axis motion of the yoke stick, and a rotational motion module 118 configured to detect rotational motion about the z-axis of the yoke stick. The user input device 100 also includes a controller 115 carried by the housing 101 and coupled to the plurality of longitudinal sensors 110a-110c, the first translation motion module 111, the second translation motion module 113, and the rotational motion module 118. The controller 115 is configured to generate the motion input signal based upon four-axis motion of the yoke stick 102.

The controller 115 may be configured to average respective output values from the plurality of longitudinal sensors 110a-110c to generate a value for the z-axis motion of the yoke stick 102. Also, the longitudinal module housing 105 illustratively defines a plurality of longitudinal channels 133a-133c, and the piston 106 illustratively defines a plurality longitudinal ridges 134a-134c respectively received by the plurality of longitudinal channels.

Further, the rotational motion module 118 illustratively includes a rotational module housing 125 coupled to an upper end of the elongate portion 103, and a plate 124 received within the rotational module housing and freely rotating therein, the plate being coupled to an uppermost end of the yoke stick 102. The rotational motion module 118 illustratively includes a plurality of rotational sensors 110d-110f carried by the plate 124 and configured to detect a rotational position of the plate with respect to the rotational module housing 125. Each of the first translation motion module 111 and the second translation motion 113 module illustratively includes a pivot bar 135, and support arms 136a-136b coupled thereto. The pivot bar of the second translation motion module 113 is coupled to the support arms 136a-136b of the first translation motion module 111.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A user input device comprising:
a housing;
a yoke stick extending from the housing and comprising
an elongate portion,
a longitudinal motion module receiving the elongate portion and comprising
a longitudinal module housing,
a piston longitudinally received within the longitudinal module housing,
first and second elastic devices carried within the longitudinal module housing and biasing the piston in a medial position, and
at least one longitudinal sensor carried by the longitudinal module housing and configured to detect z-axis motion of the yoke stick;
a first translation motion module coupled to the longitudinal motion module and configured to detect x-axis motion of the yoke stick,
a second translation motion module coupled to the first translation motion module and configured to detect y-axis motion of the yoke stick, and
a rotational motion module configured to detect rotational motion about the z-axis of the yoke stick; and
a controller carried by the housing and coupled to the at least one longitudinal sensor, the first translation motion module, the second translation motion module, and the rotational motion module, the controller configured to generate a motion input signal based upon four-axis motion of the yoke stick.

2. The user input device of claim 1 wherein the at least one longitudinal sensor comprises a plurality of longitudinal sensors radially spaced about the longitudinal module housing; and wherein the longitudinal motion module comprises a plurality of magnets carried by the piston.

3. The user input device of claim 2 wherein the controller is configured to average respective output values from the plurality of longitudinal sensors to generate a value for the z-axis motion of the yoke stick.

4. The user input device of claim 1 wherein the longitudinal module housing defines a plurality of longitudinal channels; and wherein the piston defines a plurality longitudinal ridges respectively received by the plurality of longitudinal channels.

5. The user input device of claim 1 wherein the rotational motion module comprises a rotational module housing coupled to an upper end of the elongate portion, and a plate received within the rotational module housing and freely rotating therein, the plate being coupled to an uppermost end of the yoke stick.

6. The user input device of claim 5 wherein the rotational motion module comprises a plurality of rotational sensors carried by the plate and configured to detect a rotational position of the plate with respect to the rotational module housing.

7. The user input device of claim 1 wherein each of the first translation motion module and the second translation motion module comprises a pivot bar, and support arms coupled thereto.

8. The user input device of claim 7 wherein the pivot bar of the second translation motion module is coupled to the support arms of the first translation motion module.

9. The user input device of claim 1 wherein the at least one longitudinal sensor comprises at least one Hall effect sensor.

10. A user input device comprising:
a housing;
a yoke stick extending from the housing and comprising
an elongate portion,
a longitudinal motion module receiving the elongate portion and comprising
a longitudinal module housing,
a piston longitudinally received within the longitudinal module housing,
first and second elastic devices carried within the longitudinal module housing and biasing the piston in a medial position,
a plurality of longitudinal sensors radially spaced about the longitudinal module housing and configured to detect z-axis motion of the yoke stick, and
a plurality of magnets carried by the piston;
a first translation motion module coupled to the longitudinal motion module and configured to detect x-axis motion of the yoke stick,
a second translation motion module coupled to the first translation motion module and configured to detect y-axis motion of the yoke stick, and
a rotational motion module configured to detect rotational motion about the z-axis of the yoke stick and comprising
a rotational module housing coupled to an upper end of the elongate portion, and
a plate received within the rotational module housing and freely rotating therein, the plate being coupled to an uppermost end of the yoke stick; and
a controller carried by the housing and coupled to the plurality of longitudinal sensors, the first translation motion module, the second translation motion module, and the rotational motion module, the controller configured to generate a motion input signal based upon four-axis motion of the yoke stick.

11. The user input device of claim 10 wherein the controller is configured to average respective output values from the plurality of longitudinal sensors to generate a value for the z-axis motion of the yoke stick.

12. The user input device of claim 10 wherein the longitudinal module housing defines a plurality of longitudinal channels; and wherein the piston defines a plurality longitudinal ridges respectively received by the plurality of longitudinal channels.

13. The user input device of claim 10 wherein the rotational motion module comprises a plurality of rotational sensors carried by the plate and configured to detect a rotational position of the plate with respect to the rotational module housing.

14. The user input device of claim 10 wherein each of the first translation motion module and the second translation motion module comprises a pivot bar, and support arms coupled thereto.

15. The user input device of claim 14 wherein the pivot bar of the second translation motion module is coupled to the support arms of the first translation motion module.

16. The user input device of claim 10 wherein each of the plurality of longitudinal sensors comprises at least one Hall effect sensor.

17. An unmanned aerial vehicle (UAV) system comprising:
a UAV; and
a user input device in communication with the UAV and configured to control the UAV based upon a motion input signal, the user input device comprising
a housing,
a yoke stick extending from the housing and comprising
an elongate portion,
a longitudinal motion module receiving the elongate portion and comprising
a longitudinal module housing,
a piston longitudinally received within the longitudinal module housing,
first and second elastic devices carried within the longitudinal module housing and biasing the piston in a medial position, and
at least one longitudinal sensor carried by the longitudinal module housing and configured to detect z-axis motion of the yoke stick,
a first translation motion module coupled to the longitudinal motion module and configured to detect x-axis motion of the yoke stick,
a second translation motion module coupled to the first translation motion module and configured to detect y-axis motion of the yoke stick, and
a rotational motion module configured to detect rotational motion about the z-axis of the yoke stick, and
a controller carried by the housing and coupled to the at least one longitudinal sensor, the first translation motion module, the second translation motion module, and the rotational motion module, the controller configured to generate the motion input signal based upon four-axis motion of the yoke stick.

18. The UAV system of claim 17 further comprising a folding platform to be carried by a user, and carrying the user input device.

19. The UAV system of claim 17 wherein the at least one longitudinal sensor comprises a plurality of longitudinal sensors radially spaced about the longitudinal module housing; wherein the longitudinal motion module comprises a plurality of magnets carried by the piston; and wherein the controller is configured to average respective output values from the plurality of longitudinal sensors to generate a value for the z-axis motion of the yoke stick.

20. The UAV system of claim 17 wherein the longitudinal module housing defines a plurality of longitudinal channels; and wherein the piston defines a plurality longitudinal ridges respectively received by the plurality of longitudinal channels.
